(19) United States
(12) Patent Application Publication
(10) Pub. No.: US 2025/0349900 A1
(43) Pub. Date: Nov. 13, 2025

(54) ELECTROLYTES INCLUDING PHOSPHATE TRIESTER SOLVENTS FOR BATTERIES THAT CYCLE LITHIUM IONS AND BATTERIES INCLUDING THE SAME

(71) Applicant: GM GLOBAL TECHNOLOGY OPERATIONS LLC, Detroit, MI (US)

(72) Inventors: Yan WU, Shanghai (CN); Xin ZHANG, Shanghai (CN); Haijing LIU, Shanghai (CN)

(21) Appl. No.: 18/762,781

(22) Filed: Jul. 3, 2024

(30) Foreign Application Priority Data
May 10, 2024 (CN) 2024105787163

(51) Int. Cl. H01M 10/0569; H01M 4/02; H01M 4/58; H01M 10/0525; H01M 10/0568

(52) U.S. Cl. CPC H01M 10/0569; H01M 4/5825; H01M 10/0525; H01M 10/0568; H01M 2004/028; H01M 2300/0034; H01M 2300/0037; H01M 2300/004

(57) ABSTRACT

An electrolyte for a battery that cycles lithium ions includes an organic solvent and a lithium salt in the organic solvent. The organic solvent includes a primary solvent component and a secondary solvent component. The primary solvent component includes a phosphate triester having the formula R¹O—P(═O)(OR²)(OR³), wherein R1, R2, and R3 are each individually a fluorinated or nonfluorinated organic group selected from the group consisting of hydrocarbyl, heterohydrocarbyl, silyl, siloxy, alkoxysilyl, cyano, and alkylcyano. The lithium salt includes lithium nitrate (LiNO3). The lithium nitrate is present in the organic solvent at a concentration of greater than or equal to 0.5 moles per liter and less than or equal to 4 moles per liter. The electrolyte is configured to provide a medium for the conduction of lithium ions between a negative electrode including a lithium-based electroactive negative electrode material and a positive electrode including an olivine-type lithium transition metal oxide.

### CROSS-REFERENCE TO RELATED APPLICATIONS

This application claims the benefit of Chinese Patent Application No. 202410578716.3, filed on May 10, 2024. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to electrolytes for batteries that cycle lithium ions, and more particularly to electrolytes including phosphate triester solvents formulated to improve the thermal and electrochemical stability of batteries that include lithium-based electroactive negative electrode materials.

Batteries that cycle lithium ions generally include a positive electrode, a negative electrode spaced apart from the positive electrode, and an ionically conductive electrolyte that provides a medium for the conduction of lithium ions between the positive and negative electrodes during discharge and charge of the batteries. The electrolyte may be formulated to exhibit certain desirable properties including high ionic conductivity, high dielectric constant (correlated with a high ability to dissolve salts), good thermal stability, a wide electrochemical stability window, ability to form stable ionically conductive solid electrolyte interphases on surfaces of the positive electrode and/or the negative electrode, and good chemical compatibility with other components of the batteries.

### SUMMARY

An electrolyte for a battery that cycles lithium ions, in accordance with one or more embodiments of the present disclosure, comprises an organic solvent and a lithium salt in the organic solvent. The organic solvent comprises a primary solvent component and a secondary solvent component. The primary solvent component comprising a phosphate triester having the formula (1):

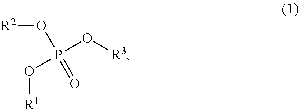

wherein R¹, R², and R³ are each individually a fluorinated or nonfluorinated organic group selected from the group consisting of hydrocarbyl, heterohydrocarbyl, silyl, siloxy, alkoxysilyl, cyano, and alkylcyano. The lithium salt comprises lithium nitrate (LiNO₃). The lithium nitrate is present in the organic solvent at a concentration of greater than or equal to 0.5 moles per liter and less than or equal to 4 moles per liter.

The LiNO₃ may be present in the organic solvent at a concentration of greater than or equal to 0.8 moles per liter and less than or equal to 2 moles per liter.

The primary solvent component may comprise at least one phosphate triester selected from the group consisting of tris(ethyl) phosphate (TEP), tris(2,2,2-trifluoroethyl) phosphate, tris(2-cyanoethyl) phosphate, and tris(trimethylsilyl) phosphate.

The phosphate triester of formula (1) may have a boiling point of greater than or equal to 150 degrees Celsius at 1 Atmosphere.

The phosphate triester of formula (1) may have a melting point of less than or equal to −20 degrees Celsius at 1 Atmosphere.

The primary solvent component may constitute, by volume, greater than or equal to 40% and less than or equal to 80% of the organic solvent.

The secondary solvent component may comprise an organic carbonate, an ether, or a combination thereof.

A viscosity of the phosphate triester of formula (1) may be greater than that of the secondary solvent component.

The secondary solvent component may comprise propylene carbonate (PC) or a mixture of fluoroethylene carbonate (FEC) and diethyl carbonate (DEC).

The secondary solvent component may constitute, by volume, greater than or equal to 20% and less than or equal to 60% of the organic solvent.

The lithium salt further may comprise at least one secondary lithium salt selected from the group consisting of lithium hexafluorophosphate (LiPF₆), lithium difluorophosphate (LiPO₂F₂), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium hexafluoroarsenate (LiAsF₆), lithium trifluoromethanesulfonate (LiCF₃SO₃), lithium bis(trifluoromethanesulfonyl)imide (LiN(CF₃SO₂)₂), lithium bis(fluorosulfonyl)imide (LiN(FSO₂)₂), lithium tetraphenylborate (LiB(C₆H₅)₄), lithium bis(oxalato) borate (LiB(C₂O₄)₂), and lithium difluoro (oxalato) borate (LiBF₂(C₂O₄)).

In such case, the at least one secondary lithium salt may be present in the organic solvent at a concentration of greater than zero moles per liter and less than or equal to 0.5 moles per liter.

The electrolyte further may comprise at least one additive selected from the group consisting of include succinic anhydride (SA), 1,3,2-dioxathiolane-2,2-dioxide (DTD), tris(trimethylsilyl) phosphite (TMSPi), trimethylsilyl (TMSi), 1,3-dioxolane (DOL), and 1,4-dioxane (DOX). In such case, the at least one additive may constitute, by weight, greater than 0% and less than or equal to 5% of the electrolyte.

A battery that cycles lithium ions, in accordance with one or more embodiments of the present disclosure, comprises a negative electrode, a positive electrode spaced apart from the negative electrode, and an electrolyte configured to provide a medium for the conduction of lithium ions between the negative electrode and the positive electrode. The negative electrode comprises a lithium-based electroactive negative electrode material. The positive electrode comprises an electroactive positive electrode material comprising an olivine-type lithium transition metal oxide represented by the formula LiMePO₄, where Me is a transition metal selected from the group consisting of Co, Ni, Mn, Fe, Al, and V. The electrolyte comprises an organic solvent and a lithium salt in the organic solvent. The organic solvent comprises a primary solvent component and a secondary solvent component. The primary solvent component comprising a phosphate triester having the formula (1):

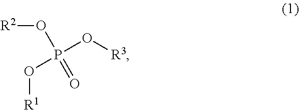

wherein R¹, R², and R³ are each individually a fluorinated or nonfluorinated organic group selected from the group consisting of hydrocarbyl, heterohydrocarbyl, silyl, siloxy, alkoxysilyl, cyano, and alkylcyano. The phosphate triester of formula (1) has a boiling point of greater than or equal to 150 degrees Celsius at 1 Atmosphere. The lithium salt comprises lithium nitrate (LiNO₃). The lithium nitrate is present in the organic solvent at a concentration of greater than or equal to 0.8 moles per liter and less than or equal to 2 moles per liter.

The primary solvent component may comprise at least one phosphate triester selected from the group consisting of tris(ethyl) phosphate (TEP), tris(2,2,2-trifluoroethyl) phosphate, tris(2-cyanoethyl) phosphate, and tris(trimethylsilyl) phosphate.

The secondary solvent component may comprise propylene carbonate (PC) or a mixture of fluoroethylene carbonate (FEC) and diethyl carbonate (DEC).

The primary solvent component may constitute, by volume, greater than or equal to 40% and less than or equal to 50% of the organic solvent.

The secondary solvent component may constitute, by volume, greater than or equal to 40% and less than or equal to 50% of the organic solvent.

The lithium-based electroactive negative electrode material may comprise greater than 50% lithium.

The electroactive positive electrode material may comprise LiFePO₄ (LFP).

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a schematic perspective view of an automotive vehicle powered by a battery pack that includes multiple battery modules.

FIG. 2 is a schematic cross-sectional view of a portion of one of the battery modules of FIG. 1, the battery module including multiple electrochemical cells or batteries that cycle lithium ions.

FIG. 3 is a schematic cross-sectional view of a battery that cycles lithium ions, the battery comprising a negative electrode, a positive electrode, a porous separator, and an electrolyte infiltrating the porous separator and configured to provide a medium for the conduction of lithium ions between the negative electrode and the positive electrode.

In the drawings, reference numbers may be reused to identify similar and/or identical elements.

### DETAILED DESCRIPTION

The presently disclosed electrolytes are formulated for use in batteries that cycle lithium ions, particularly batteries that include lithium-based electroactive negative electrode materials to help improve the thermal and electrochemical stability thereof. The presently disclosed electrolytes include phosphate triester solvents formulated with relatively high boiling points that can effectively mitigate gasification in batteries that cycle lithium ions, even when the batteries are operating at elevated temperatures, for example, at temperatures greater than 100 degrees Celsius (° C.), optionally greater than 120° C., or optionally greater than or equal to 150° C. By contrast, batteries including ethers or organic carbonates as electrolyte solvents (without the presently disclosed phosphate triester solvents) may experience gasification when operating at temperatures of greater than about 80° C., or greater than about 120° C., due to the relatively low boiling point of ether and organic carbonate solvents, which may lead to undesirable swelling of the batteries, leakage of electrolyte therefrom, and may undesirably expose the battery components to air. In addition, the presently disclosed phosphate triester solvents can effectively solvate relatively high concentrations of lithium nitrate (LiNO₃), as compared to ether and organic carbonate solvents. The inclusion of such high LiNO₃ concentrations (e.g., greater than 0.5 Molar) in the electrolytes of batteries that include lithium-based electroactive negative electrode materials (e.g., lithium metal negative electrodes), can help promote the formation of uniform, stable, nitrogen-containing solid electrolyte interphases (SEI) on the lithium-based electroactive negative electrode materials during initial cycling of the batteries, which may help mitigate the formation of lithium dendrites and improve the cycling stability and capacity retention of the batteries.

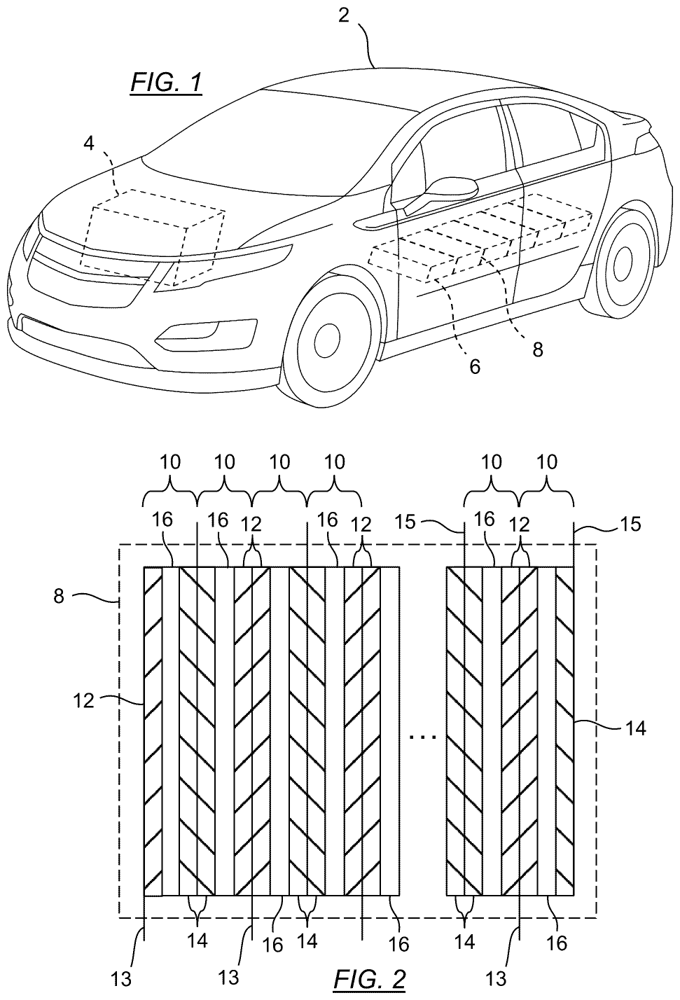

FIG. 1 depicts an automotive vehicle 2 powered by an electric motor 4 that draws electricity from a battery pack 6 including one or more battery modules 8. The battery modules 8 may be electrically coupled together in a series and/or parallel arrangement to meet desired capacity and power requirements of the electric motor 4. The vehicle 2 may be an all-electric vehicle and may be powered exclusively by the electric motor 4, or the vehicle 2 may be a hybrid electric vehicle and may be powered by the electric motor 4 and by an internal combustion engine (not shown).

As shown in FIG. 2, each battery module 8 includes one or more electrochemical cells or batteries 10 that cycle lithium ions. In practice, the batteries 10 in the battery module 8 are oftentimes assembled as a stack of layers, including negative electrode layers 12, negative electrode current collectors 13, positive electrode layers 14, positive electrode current collectors 15, and separator layers 16. Each battery 10 is defined by a negative electrode layer 12 and a positive electrode layer 14, which are spaced apart from each other by a separator layer 16. In practice, the separator layer 16 may be infiltrated with an electrolyte that provides a medium for the conduction of lithium ions between the negative electrode layer 12 and the positive electrode layer 14, or the separator layer 16 itself may function as an electrolyte. The negative electrode layers 12 are disposed on and in electrical communication with the negative electrode current collectors 13 and the positive electrode layers 14 are disposed on an in electrical communication with the positive electrode current collectors 15. As shown in FIG. 2, for efficiency, the layers may be stacked such that some of the negative electrode current collectors 13 and some of the positive electrode current collectors 15 are double sided and respectively include negative electrode layers 12 or positive electrode layers 14 on both sides thereof. In this arrangement, adjacent negative electrode layers 12 and positive electrode layers 14 respectively share a single negative electrode current collector 13 or a positive electrode current collector 15.

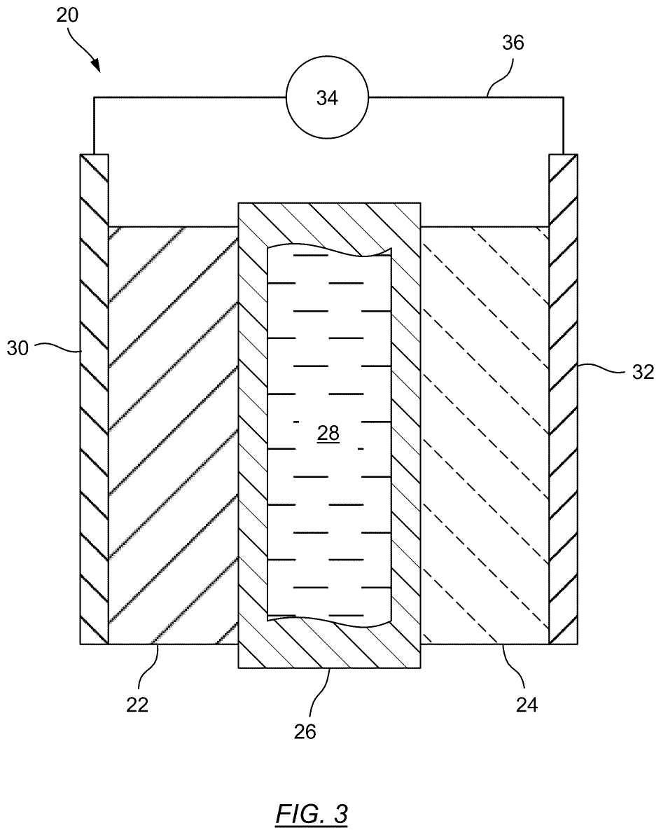

FIG. 3 depicts an electrochemical cell or battery 20 that cycles lithium ions. The battery 20 can generate an electric current during discharge, which may be used to supply power to a load device (e.g., the electric motor 4), and can be charged by being connected to a power source. Like the batteries 10 depicted in FIGS. 1 and 2, in aspects, the battery 20 may be used to supply power to an electric motor 4 of an automotive vehicle 2. Additionally or alternatively, the battery 20 may be used in other transportation applications (e.g., motorcycles, boats, tractors, buses, motorcycles, mobile homes, campers, tanks, and aircraft), and may be used to provide electricity to stationary and/or portable electronic equipment, components, and devices used in a wide variety of other industries and applications, including industrial, residential, and commercial buildings, consumer products, industrial equipment and machinery, agricultural or farm equipment, and heavy machinery, by way of nonlimiting example.

The battery 20 comprises a negative electrode 22, a positive electrode 24, a separator 26, and an electrolyte 28 that provides a medium for conduction of lithium ions between the negative electrode 22 and the positive electrode 24. The negative electrode 22 is disposed on a major surface of a negative electrode current collector 30 and the positive electrode 24 is disposed on a major surface of a positive electrode current collector 32. In practice, the negative electrode current collector 30 and the positive electrode current collector 32 are electrically coupled to a power source or load 34 (e.g., the electric motor 4) via an external circuit 36. The negative electrode 22 and the positive electrode 24 are formulated such that, when the battery 20 is at least partially charged, an electrochemical potential difference is established between the negative electrode 22 and the positive electrode 24. During discharge of the battery 20, the electrochemical potential established between the negative electrode 22 and the positive electrode 24 drives spontaneous reduction and oxidation (redox) reactions within the battery 20 and the release of lithium ions and electrons from the negative electrode 22. The released lithium ions travel from the negative electrode 22 to the positive electrode 24 through the separator 26 and the electrolyte 28, while the electrons travel from the negative electrode 22 to the positive electrode 24 via the external circuit 36, which generates an electric current. After the negative electrode 22 has been partially or fully depleted of lithium, the battery 20 may be charged by connecting the negative electrode 22 and the positive electrode 24 to the power source 34, which drives nonspontaneous redox reactions within the battery 20 and the release of the lithium ions and the electrons from the positive electrode 24. The repeated discharge and charge of the battery 20 may be referred to herein as “cycling,” with a full charge event followed by a full discharge event being considered a full cycle.

The negative electrode 22 is formulated to store and release lithium ions to facilitate charge and discharge, respectively, of the battery 20. The negative electrode 22 may be in the form of a continuous layer of material disposed on a major surface of the negative electrode current collector 30. The negative electrode 22 comprises a lithium-based electrochemically active (electroactive) material and may comprise, by weight, greater than 50% lithium, optionally greater than or equal to 60% lithium, optionally greater than or equal to 70% lithium, optionally greater than or equal to 80% lithium, optionally greater than or equal to 90% lithium, or optionally greater than or equal to 99% lithium. In aspects, the lithium-based electroactive material of the negative electrode 22 may comprise an alloy of lithium and at least one metal element selected from the group consisting of aluminum (Al), silver (Ag), silicon (Si), indium (In), and tin (Sn). In aspects, the negative electrode 22 may be nonporous and may be substantially free of a polymer binder. In addition, the negative electrode 22 may be substantially free of carbon, carbon-based materials (e.g., graphite, activated carbon, carbon black, and graphene), silicon, transition metal oxides, transition metal phosphides, transition metal sulfides, and/or transition metal nitrides.

The positive electrode 24 is formulated to store and release lithium ions during discharge and charge of the battery 20. The positive electrode 24 may be in the form of a continuous porous layer disposed on the major surface of the positive electrode current collector 32. The positive electrode 24 comprises an electrochemically active (electroactive) material (electroactive positive electrode material), a polymer binder, and optionally an electrically conductive material. In aspects, the electroactive material of the positive electrode 24 may be a particulate material and particles of the electroactive material of the positive electrode 24 may be intermingled with the polymer binder and the optional electrically conductive material.

The electroactive material of the positive electrode 24 can store and release lithium ions by undergoing a reversible redox reaction with lithium at a higher electrochemical potential than the electrochemically active material of the negative electrode 22 such that an electrochemical potential difference exists between the negative electrode 22 and the positive electrode 24. In aspects, the electroactive material of the positive electrode 24 may comprise an intercalation host material that can undergo the reversible insertion or intercalation of lithium ions, for example, the electroactive material of the positive electrode 24 may comprise a lithium transition metal oxide. In aspects, the electroactive material of the positive electrode 24 may comprise an olivine-type lithium transition metal oxide represented by the formula LiMePO₄, where Me is a transition metal (e.g., Co, Ni, Mn, Fe, Al, V, or a combination thereof). Examples of olivine-type lithium transition metal oxide electroactive positive electrode materials include LiFePO₄ (LFP), LiCoPO₄, LiMnPO₄, LiNiPO₄, and combinations thereof. In aspects, the electroactive material of the positive electrode 24 may comprise LiFePO₄. The electroactive material of the positive electrode 24 may constitute, by weight, greater than or equal to 80%, or optionally greater than or equal to 90%, and less than or equal to 98%, or optionally less than or equal to about 95%, of the positive electrode 24.

The polymer binder of the positive electrode 24 is electrochemically inactive and may be included in the positive electrode 24 to provide the positive electrode 24 with structural integrity and/or to help the positive electrode 24 adhere to the major surface of the positive electrode current collector 32. Examples of polymer binders include polyvinylidene fluoride (PVdF), polytetrafluoroethylene (PTFE), ethylene propylene diene monomer (EPDM) rubber, styrene butadiene rubber (SBR), carboxymethyl cellulose (CMC), nitrile butadiene rubber (NBR), styrene-butadiene rubber (SBR), styrene ethylene butylene styrene copolymer (SEBS), polyacrylates, alginates, polyacrylic acid, and combinations thereof. The polymer binder may constitute, by weight, greater than or equal to 1%, or optionally greater than or equal to 5%, and less than or equal to 20% of the positive electrode 24.

The optional electrically conductive material of the positive electrode 24 is electrochemically inactive and may be included in the positive electrode 24 to provide the positive electrode 24 with sufficient electrical conductivity to support the percolation of electrons therethrough. Examples of electrically conductive materials include carbon-based materials, metals (e.g., nickel), and/or electrically conductive polymers. Examples of electrically conductive carbon-based materials include carbon black (CB)(e.g., acetylene black), graphite, graphene (e.g., graphene nanoplatelets, GNP), graphene oxide, carbon nanotubes (CNT), and/or carbon fibers (e.g., carbon nanofibers). Examples of electrically conductive polymers include polyaniline, polythiophene, polyacetylene, and/or polypyrrole. When included in the positive electrode 24, the optional electrically conductive material may constitute, by weight, greater than 0%, optionally greater than or equal to 5%, or optionally greater than or equal to 10%, and less than or equal to 30% of the positive electrode 24.

The separator 26 physically separates and electrically isolates the negative electrode 22 and the positive electrode 24 from each other while permitting lithium ions to pass therethrough. The separator 26 has an open microporous structure and may comprise an organic and/or inorganic material. For example, the separator 26 may comprise a polymer. Examples of polymers for the separator 26 include polyolefins (e.g., polyethylene, PE, and/or polypropylene, PP), polyamide (PA), poly(tetrafluoroethylene)(PTFE), polyvinylidene fluoride (PVDF), poly(vinyl chloride) (PVC), and combinations thereof. In one form, the separator 26 may comprise a laminate of polymers, e.g., a laminate of PE and PP. In aspects, the separator 26 may comprise a ceramic coating (not shown) disposed on one or both sides thereof. In such case, the ceramic coating may comprise particles of alumina (Al₂O₃) and/or silica (SiO₂).

The electrolyte 28 is ionically conductive and is configured to provide a medium for the conduction of lithium ions between the negative electrode 22 and the positive electrode 24. In addition, the electrolyte 28 is formulated to improve the electrochemical performance and cycle life of the battery 20, for example, by preventing or inhibiting undesirable chemical reactions from occurring between the components of the battery 20, which might otherwise lead to reduced capacity retention after repeated cycling of the battery 20. The electrolyte 28 comprises an organic solvent, a lithium salt, and an optional additive.

The organic solvent in the electrolyte 28 comprises a mixture of a primary solvent component and a secondary solvent component. A volumetric ratio of the primary solvent component to the secondary solvent component (primary solvent component: secondary solvent component) in the organic solvent may be greater than or equal to 2:3, or optionally greater than or equal to 5:4, and less than or equal to 4:1, or optionally less than or equal to 3:2. The organic solvent may constitute, by weight, greater than or equal to 80%, or optionally greater than or equal to 85%, and less than or equal to 95%, or optionally less than or equal to 90% of the electrolyte 28.

The primary solvent component is formulated to have a relatively high boiling point to help prevent or inhibit gasification and swelling of the battery 20 at high operating temperatures (e.g., at temperatures greater than 100° C., optionally greater than 120° C., or optionally greater than or equal to 150° C.). In addition, the primary solvent component may be formulated to have a low melting point to provide the battery 20 with good performance at low operating temperatures. For example, the primary solvent component may have a melting point of less than or equal to 5° C., optionally less than or equal to −20° C., or optionally less than or equal to −50° C. and a boiling point of greater than or equal to 150° C., optionally greater than or equal to 180° C., optionally greater than or equal to 200° C., or optionally greater than or equal to 220° C. at 1 Atmosphere (Atm). In addition, the primary solvent component is formulated to effectively solvate the lithium salt in the electrolyte 28 and to provide the electrolyte 28 with thermal stability and flame-retardant properties. The primary solvent component may constitute, by volume, greater than or equal to 40%, optionally greater than or equal to 45%, or optionally greater than or equal to 50%, and less than or equal to 80%, optionally less than or equal to 60%, or optionally less than or equal to 55% of the organic solvent.

The primary solvent component comprises a phosphate triester having the formula (1):

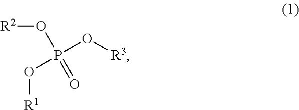

where R¹, R², and R³ are each individually a fluorinated or nonfluorinated organic group selected from the group consisting of hydrocarbyl, heterohydrocarbyl, silyl, siloxy, alkoxysilyl, cyano, and alkylcyano.

“Hydrocarbyl” means a functional group containing only hydrogen and carbon atoms, including branched or unbranched, saturated or unsaturated, cyclic, polycyclic or acyclic groups. Hydrocarbyls are formed by removing at least one hydrogen atom from a hydrocarbon molecule. According to the number of removed hydrogen atoms, a hydrocarbyl can be monovalent (formed by removing one hydrogen atom, also referred to as a hydrocarbyl group), divalent (formed by removing two hydrogen atoms, also referred to as a hydrocarbylene group), and the like. Examples of monovalent hydrocarbyls include alkyl, cycloalkyl, alkenyl, cycloalkenyl, aryl, and alkynyl groups. Examples of divalent hydrocarbyls include alkylene, cycloalkylene, alkenylene, alkynylene, and arylene groups.

“Heterohydrocarbyl” means a hydrocarbyl in which at least one of the carbon atoms is replaced with a heteroatom, e.g., nitrogen, oxygen, sulfur, phosphorus, boron, or silicon. Examples of heterohydrocarbyls include alkoxy, aryloxy, and ether (e.g., —CH₂OCH₃).

“Silyl” means a functional group having the formula —SiR′R″R″, where R′, R″, and R′″ are each individually H, hydrocarbyl, or heterohydrocarbyl.

“Siloxy” means a functional group having the formula —OSiR′R″R″, where R′, R″, and R″ are each individually H, hydrocarbyl, or heterohydrocarbyl.

“Alkoxysilyl” means a functional group having the formula —Si(OR)₃, where R is H, hydrocarbyl, heterohydrocarbyl, or —Si(OR)₃.

“Cyano” means a functional group having the formula —C≡N.

“Cyanoalkyl” means a functional group having the formula —R′C≡N, where R′ is a divalent hydrocarbyl.

A “fluorinated” organic group is an organic group in which at least one hydrogen atom bound to a carbon atom is replaced with a fluorine (F) atom. An organic group may be polyfluorinated, in which more than one of the H atoms are replaced with an F atom, or the organic group may be perfluorinated, in which all the H atoms are replaced with F atoms.

In aspects, R¹, R², and R³ in the phosphate triester of formula (1) may comprise ethyl groups (—CH₂CH₃), and the primary solvent component may comprise tris(ethyl) phosphate (TEP), having a melting point of about −56.5° C. and a boiling point of about 215° C. at 1 Atmosphere (Atm).

In aspects, R¹, R², and R³ in the phosphate triester of formula (1) may comprise trifluoroethyl groups (—CH₂CF₃), and the primary solvent component may comprise tris(2,2,2-trifluoroethyl) phosphate, having a melting point of about −22° C. and a boiling point of about 186° C. at 1 Atmosphere (Atm).

In aspects, R¹, R², and R³ in the phosphate triester of formula (1) may comprise 2-cyanoethyl groups (—CH₂CH₂CN), and the primary solvent component may comprise tris(2-cyanoethyl) phosphate, having a boiling point of about 162° C. at 1 Atm.

In aspects, R¹, R², and R³ in the phosphate triester of formula (1) may comprise trimethylsilyl groups (—Si(CH₃)₃), and the primary solvent component may comprise tris(trimethylsilyl) phosphate, having a melting point of about 4° C. and a boiling point of about 228° C. at 1 Atm.

The secondary solvent component has a relatively low viscosity, as compared to that of the primary solvent component, and is included in the electrolyte 28 to provide the electrolyte 28 with a suitably low viscosity, which may help enhance the diffusion and transport of lithium ions (Li⁺) through the electrolyte 28 and thereby improve the electrochemical performance of the battery 20. In addition, the secondary solvent component is formulated to provide the electrolyte 28 with a wide electrochemical stability window and may assist in the formation of a solid electrolyte interphase (SEI) on surfaces of the negative electrode 22 and the formation of a cathode electrolyte interphase (CEI) on surfaces of the positive electrode 24, which may help prevent or inhibit undesirable chemical reactions from occurring between the electrolyte 28 and the negative electrode 22 and the positive electrode 24, respectively, during cycling of the battery 20. The secondary solvent component may constitute, by volume, greater than or equal to 20%, optionally greater than or equal to 30%, or optionally greater than or equal to 40%, and less than or equal to 60%, optionally less than or equal to 50%, or optionally less than or equal to 40% of the organic solvent.

The secondary solvent component may comprise an organic carbonate, an ether, or a combination thereof. For example, the secondary solvent component may comprise a cyclic organic carbonate, a linear organic carbonate, an aliphatic ether, a cyclic ether, or a combination thereof. Non-limiting examples of cyclic organic carbonates include ethylene carbonate (EC), propylene carbonate (PC), fluoroethylene carbonate (FEC), and combinations thereof. Non-limiting examples of linear organic carbonates include diethyl carbonate (DEC), ethyl methyl carbonate (EMC), methyl (2,2,2-trifluoroethyl) carbonate (FEMC), di-(2,2,2 trifluoroethyl) carbonate (DFDEC), and combinations thereof. Non-limiting examples of aliphatic ethers include triethylene glycol dimethyl ether, tetraethylene glycol dimethyl ether (TEGDME), 1,3-dimethoxypropane (DMP), 1,2-dimethoxyethane (DME), and combinations thereof. Non-limiting examples of cyclic ethers include 1,4-dimethoxybenzene (DMB). In aspects, the secondary solvent component may comprise PC or a mixture of FEC and DEC. In embodiments where the secondary solvent component comprises a mixture of FEC and DEC, a volumetric ratio of the FEC to the DEC (FEC:DEC) may be greater than or equal to 1:2 and less than or equal to 1:4, e.g., a volumetric ratio of the FEC to the DEC in the secondary solvent component may be about 1:3.

The presently disclosed phosphate triesters of formula (1) can effectively solvate relatively high concentrations of lithium nitrate (LiNO₃), as compared to organic carbonates and/or ethers, and thus may allow for relatively high concentrations of dissolved LiNO₃ in the electrolyte 28. For example, the solubility of LiNO₃ in the phosphate triesters of formula (1)(e.g., TEP) may be greater than or equal to 1 mole per liter (mol/L or Molar), optionally greater than or equal to 1.5 Molar, or optionally greater than or equal to 2 Molar. By comparison, the solubility of LiNO₃ in organic carbonates (e.g., EC, PC, FEC, DEC, EMC, FEMC, and/or DFDEC) and/or ethers (e.g., TEGDME, DMP, DME, and/or DMB) may be less than 1 Molar, or less than or equal to 0.9 Molar.

The lithium salt is soluble in the organic solvent and is formulated to provide a passage for lithium ions through the electrolyte 28. The lithium salt may constitute, by weight, greater than or equal to 5%, optionally greater than or equal to about 10%, and less than or equal to 20%, or optionally less than or equal to 15% of the electrolyte 28.

The lithium salt in the electrolyte 28 comprises lithium nitrate (LiNO₃). Lithium nitrate can effectively participate in formation of a uniform, stable, nitrogen-containing solid electrolyte interphase (SEI) on surfaces of the lithium-based electroactive material of the negative electrode 22 during initial cycling of the battery 20, which may help prevent or inhibit the formation of lithium dendrites on the negative electrode 22 and improve the cycling stability and capacity retention of the battery 20. The lithium nitrate may be present in the organic solvent at a concentration of greater than or equal to 0.5 moles per liter (mol/L or Molar), optionally greater than or equal to 0.8 Molar, optionally greater than or equal to 1 Molar, or optionally greater than or equal to 1.2 Molar, and less than or equal to 4 Molar, optionally less than or equal to 3 Molar, optionally less than or equal to 2.5 Molar, optionally less than or equal to 2 Molar, optionally less than or equal to 1.8 Molar, optionally less than or equal to 1.4 Molar, or optionally less than or equal to 1.2 Molar.

In addition to LiNO₃, the lithium salt optionally may comprise one or more secondary lithium salts. Examples of secondary lithium salts that optionally may be included in the electrolyte 28 in combination with LiNO₃ include lithium hexafluorophosphate (LiPF₆), lithium difluorophosphate (LiPO₂F₂), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium hexafluoroarsenate (LiAsF₆), lithium trifluoromethanesulfonate (LiCF₃SO₃), lithium bis(trifluoromethanesulfonyl)imide (LiN(CF₃SO₂)₂)(LiTFSI), lithium bis(fluorosulfonyl)imide (LiN(FSO₂)₂)(LiFSI), lithium tetraphenylborate (LiB(C₆H₅)₄), lithium bis(oxalato) borate (LiB(C₂O₄)₂)(LiBOB), lithium difluoro (oxalato) borate (LiBF₂(C₂O₄))(LiDFOB), and combinations thereof. When present, the secondary lithium salt may be included in the organic solvent at a concentration of greater than 0 Molar, or optionally greater than or equal to 0.2 Molar, and less than or equal to 2 Molar, or optionally less than or equal to 0.5 Molar.

The optional additive may be included in the electrolyte 28 to provide the electrolyte 28 and/or the battery 20 with certain desirable properties. For example, the optional additive may be formulated to assist in formation of the SEI on the negative electrode 22, formation of the CEI on the positive electrode 24, scavenge hydrofluoric acid (HF), and/or prevent or suppress transition metal ion dissolution from the positive electrode 24. Examples of additives that optionally may be included in the electrolyte 28 include succinic anhydride (SA), 1,3,2-dioxathiolane-2,2-dioxide (DTD), tris(trimethylsilyl) phosphite (TMSPi), trimethylsilyl (TMSi), 1,3-dioxolane (DOL), 1,4-dioxane (DOX), and combinations thereof. When present, the optional additive may be included in the electrolyte 28 in an amount constituting, by weight, greater than 0% and less than or equal to 5%, optionally less than or equal to 3%, optionally less than or equal to 1%, optionally less than or equal to 0.5%, or optionally less than or equal to 0.1% of the electrolyte 28.

The negative electrode current collector 30 and the positive electrode current collector 32 are electrically conductive, electrochemically inactive, and provide an electrical connection between the external circuit 36 and the negative electrode 22 and the positive electrode 24, respectively. In aspects, the negative electrode current collector 30 and the positive electrode current collector 32 may be made of metal and may be in the form of nonporous metal foils, perforated metal foils, porous metal meshes, or a combination thereof. The negative electrode current collector 30 may be made of copper, nickel, or alloys thereof, stainless steel, or other appropriate electrically conductive material. The positive electrode current collector 32 may be made of aluminum (Al) or another appropriate electrically conductive material.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

The terminology used herein is for the purpose of describing example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended terms “comprises,” “comprising,” “including,” and “having,” are to be understood as non-restrictive terms used to describe and claim various embodiments set forth herein, in certain aspects, the terms may alternatively be understood to instead be a more limiting and restrictive term, such as “consisting of” or “consisting essentially of.” Thus, for any given embodiment reciting compositions, materials, components, elements, ingredients, features, integers, operations, and/or process steps, the present disclosure also specifically includes embodiments consisting of, or consisting essentially of, such recited compositions, materials, components, elements, ingredients, features, integers, operations, and/or process steps. In the case of “consisting of,” the alternative embodiment excludes any additional compositions, materials, components, elements, ingredients, features, integers, operations, and/or process steps, while in the case of “consisting essentially of,” any additional compositions, materials, components, elements, ingredients, features, integers, operations, and/or process steps that materially affect the basic and novel characteristics are excluded from such an embodiment, but any compositions, materials, components, elements, ingredients, features, integers, operations, and/or process steps that do not materially affect the basic and novel characteristics can be included in the embodiment.

As used herein, the phrase at least one of A, B, and C should be construed to mean a logical (A OR B OR C), using a non-exclusive logical OR, and should not be construed to mean “at least one of A, at least one of B, and at least one of C.”

As used herein, the terms “composition” and “material” are used interchangeably to refer broadly to a substance containing at least the preferred chemical constituents, elements, or compounds, but which may also comprise additional elements, compounds, or substances, including trace amounts of impurities, unless otherwise indicated. An “X-based” composition or material broadly refers to compositions or materials in which “X” is the single largest constituent of the composition or material on a weight percentage (%) basis. This may include compositions or materials having, by weight, greater than 50% X, as well as those having, by weight, less than 50% X, so long as X is the single largest constituent of the composition or material based upon its overall weight. When a composition or material is referred to as being “substantially free” of a substance, the composition or material may comprise, by weight, less than 5%, optionally less than 3%, optionally less than 1%, or optionally less than 0.1% of the substance.

As used herein, the term “metal” may refer to a pure elemental metal or to an alloy of an elemental metal and one or more other metal or nonmetal elements (referred to as “alloying” elements). The alloying elements may be selected to impart certain desirable properties to the alloy that are not exhibited by the base metal element.

What is claimed is:

1. An electrolyte for a battery that cycles lithium ions, the electrolyte comprising:
an organic solvent comprising a primary solvent component and a secondary solvent component, the primary solvent component comprising a phosphate triester having the formula (1): 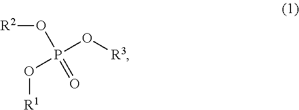
wherein R¹, R², and R³ are each individually a fluorinated or nonfluorinated organic group selected from the group consisting of hydrocarbyl, heterohydrocarbyl, silyl, siloxy, alkoxysilyl, cyano, and alkylcyano; and
a lithium salt in the organic solvent, the lithium salt comprising lithium nitrate (LiNO₃), the lithium nitrate being present in the organic solvent at a concentration of greater than or equal to 0.5 moles per liter and less than or equal to 4 moles per liter.

2. The electrolyte of claim 1, wherein the LiNO₃ is present in the organic solvent at a concentration of greater than or equal to 0.8 moles per liter and less than or equal to 2 moles per liter.

3. The electrolyte of claim 1, wherein the primary solvent component comprises at least one phosphate triester selected from the group consisting of tris(ethyl) phosphate (TEP), tris(2,2,2-trifluoroethyl) phosphate, tris(2-cyanoethyl) phosphate, and tris(trimethylsilyl) phosphate.

4. The electrolyte of claim 1, wherein the phosphate triester of formula (1) has a boiling point of greater than or equal to 150 degrees Celsius at 1 Atmosphere.

5. The electrolyte of claim 1, wherein the phosphate triester of formula (1) has a melting point of less than or equal to −20 degrees Celsius at 1 Atmosphere.

6. The electrolyte of claim 1, wherein the primary solvent component constitutes, by volume, greater than or equal to 40% and less than or equal to 80% of the organic solvent.

7. The electrolyte of claim 1, wherein the secondary solvent component comprises an organic carbonate, an ether, or a combination thereof.

8. The electrolyte of claim 7, wherein a viscosity of the phosphate triester of formula (1) is greater than that of the secondary solvent component.

9. The electrolyte of claim 1, wherein the secondary solvent component comprises propylene carbonate (PC) or a mixture of fluoroethylene carbonate (FEC) and diethyl carbonate (DEC).

10. The electrolyte of claim 1, wherein the secondary solvent component constitutes, by volume, greater than or equal to 20% and less than or equal to 60% of the organic solvent.

11. The electrolyte of claim 1, wherein the lithium salt further comprises at least one secondary lithium salt selected from the group consisting of lithium hexafluorophosphate (LiPF₆), lithium difluorophosphate (LiPO₂F₂), lithium perchlorate (LiClO₄), lithium tetrachloroaluminate (LiAlCl₄), lithium iodide (LiI), lithium bromide (LiBr), lithium thiocyanate (LiSCN), lithium tetrafluoroborate (LiBF₄), lithium hexafluoroarsenate (LiAsF₆), lithium trifluoromethanesulfonate (LiCF₃SO₃), lithium bis(trifluoromethanesulfonyl)imide (LiN(CF₃SO₂)₂), lithium bis(fluorosulfonyl)imide (LiN(FSO₂)₂), lithium tetraphenylborate (LiB(C₆H₅)₄), lithium bis(oxalato) borate (LiB(C₂O₄)₂), and lithium difluoro (oxalato) borate (LiBF₂(C₂O₄)).

12. The electrolyte of claim 11, wherein the at least one secondary lithium salt is present in the organic solvent at a concentration of greater than zero moles per liter and less than or equal to 0.5 moles per liter.

13. The electrolyte of claim 1, further comprising at least one additive selected from the group consisting of include succinic anhydride (SA), 1,3,2-dioxathiolane-2,2-dioxide (DTD), tris(trimethylsilyl) phosphite (TMSPi), trimethylsilyl (TMSi), 1,3-dioxolane (DOL), and 1,4-dioxane (DOX), wherein the at least one additive constitutes, by weight, greater than 0% and less than or equal to 5% of the electrolyte.

14. A battery that cycles lithium ions, the battery comprising:
a negative electrode comprising a lithium-based electroactive negative electrode material;
a positive electrode spaced apart from the negative electrode and comprising an electroactive positive electrode material comprising an olivine-type lithium transition metal oxide represented by the formula LiMePO₄, where Me is a transition metal selected from the group consisting of Co, Ni, Mn, Fe, Al, and V; and
an electrolyte configured to provide a medium for the conduction of lithium ions between the negative electrode and the positive electrode, the electrolyte comprising:
an organic solvent comprising a primary solvent component and a secondary solvent component, the primary solvent component comprising a phosphate triester having the formula (1): 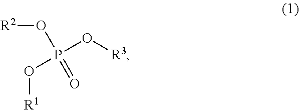
wherein R¹, R², and R³ are each individually a fluorinated or nonfluorinated organic group selected from the group consisting of hydrocarbyl, heterohydrocarbyl, silyl, siloxy, alkoxysilyl, cyano, and alkylcyano, and
wherein the phosphate triester of formula (1) has a boiling point of greater than or equal to 150 degrees Celsius at 1 Atmosphere; and
a lithium salt in the organic solvent, the lithium salt comprising lithium nitrate (LiNO₃), the lithium nitrate being present in the organic solvent at a concentration of greater than or equal to 0.8 moles per liter and less than or equal to 2 moles per liter.

15. The battery of claim 14, wherein the primary solvent component comprises at least one phosphate triester selected from the group consisting of tris(ethyl) phosphate (TEP), tris(2,2,2-trifluoroethyl) phosphate, tris(2-cyanoethyl) phosphate, and tris(trimethylsilyl) phosphate.

16. The battery of claim 15, wherein the secondary solvent component comprises propylene carbonate (PC) or a mixture of fluoroethylene carbonate (FEC) and diethyl carbonate (DEC).

17. The battery of claim 16, wherein the primary solvent component constitutes, by volume, greater than or equal to 40% and less than or equal to 50% of the organic solvent.

18. The battery of claim 17, wherein the secondary solvent component constitutes, by volume, greater than or equal to 40% and less than or equal to 50% of the organic solvent.

19. The battery of claim 14, wherein the lithium-based electroactive negative electrode material comprises greater than 50% lithium.

20. The battery of claim 14, wherein the electroactive positive electrode material comprises LiFePO₄ (LFP).
